(19) United States
(12) Patent Application Publication
(10) Pub. No.: US 2010/0228593 A1
(43) Pub. Date: Sep. 9, 2010

(54) TRACKING OFFLINE RESPONSES TO INDICATE ONLINE ADVERTISEMENT QUALITY

(75) Inventors: Subramanya Srikanth Belwadi, Bangalore (IN); Doug Raymond, San Francisco, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/397,546

(22) Filed: Mar. 4, 2009

(51) Int. Cl. G06Q 30/00; G06Q 10/00; G06F 15/16

(52) U.S. Cl. 705/10; 709/204; 705/14.41

(57) ABSTRACT

Online advertisements can include offline response mechanisms. The offline response mechanisms can be used to adjust quality scores associated with the online advertisements. The adjusted quality scores can be used to influence whether particular ads are served in future placements.

### BACKGROUND

This disclosure is related to indicating online advertisement quality.

The rise of the Internet has enabled access to a wide variety of content items, such as video and/or audio files, web pages for particular subjects, and news articles. Such access to these content items has likewise enabled opportunities for targeted advertising. For example, content items of particular interest to a user can be identified by a search engine in response to a user query. The query can include one or more search terms, and the search engine can identify and, optionally, rank the content items based on the search terms in the query. The search engine can use the ranking of the content items when presenting the content items to the user (e.g., the content items can be presented according to their rank). The query can also be an indicator of the type of information of interest to the user. By comparing the user query to a list of keywords specified by an advertiser, it is possible to provide targeted advertisements to the user.

Another form of online advertising is advertisement syndication, which allows advertisers to extend their marketing reach by distributing advertisements to additional partners. For example, third party online publishers can place an advertiser's text or image advertisements on web pages that have content related to the advertisement. Since the users of a publisher's web page are likely to be interested in the particular content on the web page, they are also likely to be interested in the product or service featured in the advertisement. Accordingly, such targeted advertisement placement can help drive online customers to the advertiser's web site.

Online advertisements also typically include sufficient information for a user to identify a business associated with the advertisement, and to pursue offline activities with that business. Efforts have been made to capture such offline activities by providing offline response mechanisms for consumers to contact the business, and to thereby adequately reward the publisher.

### SUMMARY

Systems, methods and computer readable media for indicating online advertisement quality are provided. Example methods for indicating online advertisement quality can include providing an online advertisement that includes an offline response mechanism based upon a quality score associated with the online advertisement; receiving notification of an offline response to the online advertisement; and adjusting the quality score associated with the online advertisement based upon receiving notification of the offline response.

Other implementations are disclosed, including implementations directed to systems, methods, apparatuses, computer-readable mediums and user interfaces.

### BRIEF DESCRIPTION OF DRAWINGS

FIG. 1 is a block diagram of an example network architecture that can provide offline response tracking and quality score adjustment.

FIG. 2 is a block diagram of an example advertisement quality scoring system.

FIG. 3 is a block diagram of an example offline response tracking subsystem.

FIG. 4 is a flowchart of an example method for indicating the quality of online advertisements based upon offline responses.

FIG. 5 is a flowchart of another example method for indicating the quality of online advertisements based on offline responses or online responses.

### DETAILED DESCRIPTION

### Overview

In general, the described techniques relate to indicating the quality of an online advertisement by adjusting a quality score associated with the online advertisement based upon offline responses to the advertisement. The offline responses can include, for example, telephone calls, coupon usage, electronic mail, instant messaging, and text messaging (e.g., short messaging service (SMS), enhanced messaging service (EMS), or multimedia messaging service (MMS)), which can be facilitated through offline response mechanisms included in the online advertisement (e.g., telephone number, electronic coupon, e-mail address, or text message address). Offline responses can be recorded using a tracking system. The tracking system can provide notification to a quality scoring system of the type of offline response received. The quality scoring system can adjust the quality score for the advertisement based upon the notification. Thus, credit for the offline action is applied toward the quality score for the online advertisement.

Although various examples are described with reference to advertisements, the systems and methods described in this specification can also facilitate the quality score adjustment of other types of content items having measurable performance or quality parameters, such as videos, articles and reviews.

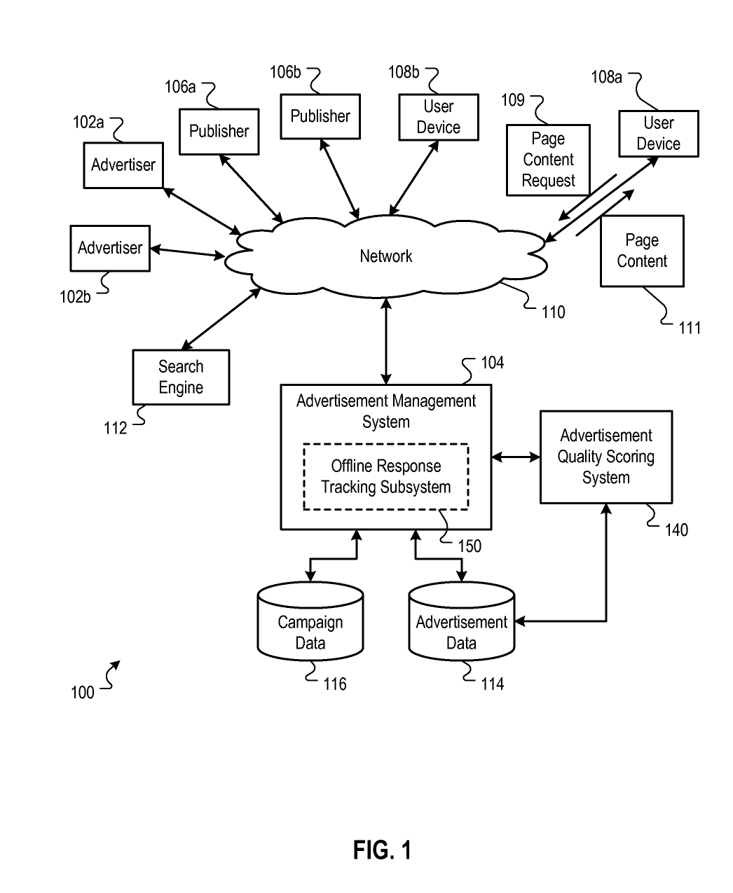

The techniques described herein can be implemented in an online environment, such as the example online environment 100 shown in FIG. 1. The online environment 100 can facilitate the identification and serving of content items, such as web pages or advertisements, to users. A computer network 110, such as a local area network (LAN), wide area network (WAN), the Internet, or a combination thereof, connects advertisers 102a and 102b, an advertisement management system 104, publishers 106a and 106b, user devices 108a and 108b, and a search engine 112. Although only two advertisers (102a and 102b), two publishers (102a and 102b) and two user devices (108a and 108b) are shown, the online environment 100 may include many thousands of advertisers, publishers and user devices.

### Advertisement Publishing and Tracking

In the online environment 100, one or more of advertisers 102a and/or 102b can directly, or indirectly, enter, maintain, and track online advertisement information in the advertising management system 104. Online advertisements can be in the form of graphical advertisements, such as banner advertisements, text only advertisements, image advertisements, audio advertisements, video advertisements, advertisements combining one or more of these advertisement types, or any other type of electronic advertisement 120. The advertisements may also include embedded information, such as a links, meta-information, and/or machine executable instructions, such as HTML or JavaScript™.

A user device, such as user device 108a, can submit a request 109 for page content 111 to a publisher or the search engine 112. In some implementations, the page content 111 can be provided to the user device 108a in response to the page content request 109. The page content can include advertisements provided by the advertisement management system 104, or can include executable instructions, e.g., JavaScript™, that can be executed at the user device 108a to request advertisements from the advertisement management system 104. Example user devices 108 include personal computers, mobile communication devices, and television set-top boxes.

Advertisements can also be provided from the publishers 106. For example, one or more of publishers 106a and/or 106b can submit advertisement requests for one or more advertisements to the system 104. The system 104 responds by sending the advertisements to the requesting publisher 106a or 106b for placement on one or more of the publisher's web properties (e.g., web sites and other network-distributed content). The advertisements can include embedding links to landing pages (e.g., pages on advertiser-affiliated web sites to which a user is directed to when the user clicks on an ad presented on a publisher web site). The advertisement requests can also include content request information. This information can include the content itself (e.g., page or other content document), a category corresponding to the content or the content request (e.g., arts, business, computers, arts-movies or arts-music), part or all of the content request, content age, content type (e.g., text, graphics, video, audio or mixed media), or geo-location information.

In some implementations, a publisher 106 can combine the requested content with one or more of the advertisements provided by the system 104. This combination of page content 109 and advertisements can be sent to the user device 108 that requested the content (e.g., user device 108a) as page content 111 for presentation in a viewer (e.g., a browser or other content display system). The publisher 106 can transmit information about the advertisements back to the advertisement management system 104, including information describing how, when, and/or where the advertisements are to be rendered (e.g., in HTML or JavaScript™).

Publishers 106a and 106b can include general content servers that receive requests for content (e.g., articles, discussion threads, music, video, graphics, search results, web page listings, or information feeds) and retrieve the requested content in response to the request. For example, content servers related to news content providers, retailers, independent blogs, social network sites, or any other entity that provides content over the network 110 can be a publisher.

Advertisements can also be provided through the use of the search engine 112. The search engine 112 can receive queries for search results. In response, the search engine 112 can retrieve relevant search results from an index of documents (e.g., from an index of web pages). Search results can include, for example, lists of web page titles, snippets of text extracted from those web pages, and hypertext links to those web pages, and may be grouped into a predetermined number of (e.g., ten) search results.

The search engine 112 can also submit a request for advertisements to the system 104. The request may include a number of advertisements desired. This number may depend on factors such as the search results, the amount of screen or page space occupied by the search results, and the size and shape of the advertisements. The request for advertisements may also include the query (as entered or parsed), information based on the query (such as geo-location information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores), snippets of text extracted from identified documents (e.g., web pages), the full text of identified documents, and feature vectors of identified documents. In some implementations, IR scores can be computed from, for example, dot products of feature vectors corresponding to a query and a document, page rank scores, and/or combinations of IR scores and page rank scores.

The search engine 112 can combine the search results with one or more of the advertisements provided by the system 104. This combined information can then be forwarded to the user device 108 that requested the content as the page content 111. The search results can be maintained as distinct from the advertisements, so as not to confuse the user between paid advertisements and presumably neutral search results.

### Online Response Tracking

The advertisers 102, user devices 108, and/or the search engine 112 can also provide usage information to the advertisement management system 104. This usage information can include measured or observed user behavior related to advertisements that have been served, such as, for example, whether a conversion or a selection related to an advertisement has occurred. The user behavior of selecting an advertisement can be referred to as an online response to the advertisement, e.g., a click-through. In some implementations, the system 104 can perform financial transactions, such as crediting the publishers 106 and charging the advertisers 102 based on the usage information. Such usage information can also be processed to measure performance metrics, such as a click-through rate (“CTR”), conversion rate, and other measurable performance metrics for online responses.

A click-through can occur, for example, when a user of a user device, selects or “clicks” on a link to a content item returned by the publisher or the advertising management system. The CTR is a performance metric that is obtained by dividing the number of users that clicked on the content item, e.g., a link to a landing page, an advertisement, or a search result, by the number of times the content item was delivered. For example, if a link to a content item is delivered 100 times, and three persons click on the content item, then the CTR for that content item is 3%. Other usage information and/or performance metrics can also be used.

A “conversion” occurs when a user consummates a transaction related to a previously served advertisement. What constitutes a conversion may vary from case to case and can be determined in a variety of ways. For example, an online conversion may occur when a user clicks on an advertisement, is referred to the advertiser's web page, and consummates a purchase there before leaving that web page. A conversion can also be defined by an advertiser to be any measurable/observable user action such as, for example, downloading a white paper, navigating to at least a given depth of a web site, viewing at least a certain number of web pages, spending at least a predetermined amount of time on a web site or web page, or registering on a web site. Other actions that constitute a conversion can also be used.

In various implementations, receipt of an online response can be communicated to an advertisement quality scoring system 140. The advertisement quality scoring system 140 can adjust a quality score associated with the advertisement based upon receiving notification of the online response.

### Offline Response Tracking

The online advertisements provided to the user can also (or instead) include an offline response mechanism operable to facilitate contact between a user and the advertiser 102a-b. In some implementations, the offline response mechanism can include a telephone number embedded into the online advertisement. The telephone number can identify an exchange (e.g., a private branch exchange (PBX)) associated with an offline response tracking subsystem 150. Upon receiving a call (e.g., a connection request) addressed to the telephone number identified in the online advertisement, the exchange can identify a recipient (e.g., a business associated with the advertisement) and route the call to the recipient. The PBX can also be programmed to signal the offline response tracking subsystem 150 that an offline response associated with the advertisement was received.

In other implementations, other offline response mechanisms can be included within the online advertisement. Such offline response mechanisms can include, for example, text messaging, one or more coupons, instant messaging identification, or an e-mail address. In some implementations, the offline response mechanisms can request a storefront address, whereby the advertisement can interface with a global positioning system (GPS) to determine when a user has visited a storefront associated with the advertisement. Such implementations can obfuscate user information to alleviate privacy concerns. When a user selects one of the offline response mechanisms, an offline response can be identified and tracked by the offline response tracking subsystem 150.

In response to receiving an offline response associated with the advertisement, the offline response tracking subsystem 150 can notify an advertisement quality scoring system 140 of receipt of the offline response. The advertisement quality scoring system 140 can adjust a quality score associated with the advertisement based upon receiving notification of the offline response.

In some implementations, the advertisement quality scoring system 140 can differentiate between types of offline responses. For example, use of a coupon indicates that the user has made a purchase from a business associated with the advertiser 102a-b. A purchase of goods or services can be identified as a better indication of quality than a click-through or a telephone call. Similarly, a telephone call requires more effort than a click-through, and thereby can be considered to provide a better indication of advertisement quality than the click-through. Thus, rules can be provided whereby the quality score of an advertisement is adjusted based upon the type of offline response (or online response) received.

While in this example, the offline response tracking subsystem 150 is shown as a subsystem to the advertisement management system 104, in some implementations, the offline response tracking subsystem can be a component of various other devices used to route offline responses (e.g., a PBX, an e-mail server, an IM server or a text message server). In still further implementations, the offline response tracking subsystem can be provided as a standalone component.

### Advertisement Auctioning and Management

In addition to the advertisements being selected based on content such as a search query or web page content of a publisher, the advertisements can also be selected from other selection processes, such as an auction. In one implementation, the advertisement management system 104 includes an auction process. Advertisers 102 may be permitted to select, or bid, an amount the advertisers are willing to pay for each click of an advertisement, e.g., a cost-per-click amount an advertiser pays when, for example, a user clicks on an advertisement. The cost-per-click can include a maximum cost-per-click, e.g., the maximum amount the advertiser is willing to pay for each click of an advertisement based on a keyword. For example, advertisers A, B, and C all select, or bid, a maximum cost-per-click of $0.50, $0.75, and $1.00, respectively. The maximum amount advertiser A will pay for a click is $0.50, the maximum amount advertiser B will pay is $0.75, and the maximum amount advertiser C will pay is $1.00.

The position, or rank, of an advertisement, such as where the advertisement is displayed next to search results or in which slot an advertisement will be displayed on a publisher page, can be a function of the cost-per-click multiplied by a quality score associated with the advertisement. A quality score can be the basis for measuring the quality and relevance of an advertisement. The quality score can, for example, be determined by the advertisement's click-through rate, the relevance of the advertisement text, overall historical keyword performance, and the user experience on a landing page associated with the advertisement. Other parameters can also be used to determine a quality score.

The rank of an advertisement that is displayed can be determined by multiplying the maximum cost-per-click for the advertisement by a quality score of the advertisement. The advertisement can then be placed among other advertisements in order of increasing or decreasing rank. For example, suppose the quality score of advertisers A, B, and C are “3,” “1,” and “1,” respectively. The rank of advertiser A, B, and C can be determined as follows:

A: Rank=quality score×maximum cost-per-click=3.0×$0.50=1.50

B: Rank=quality score×maximum cost-per-click=1.0×$0.75=0.75

C: Rank=quality score×maximum cost-per-click=1.0×$1.00=1.00

The advertisers can be ranked as follows:

1. A

2. C

3. B

An advertisement can also be associated with an actual cost-per-click. The actual cost-per-click of the advertisement can be determined by the maximum cost-per-click of the advertisement, the quality score of the advertisement, and the amount selected or bid by the advertiser directly below. In one implementation, the actual cost-per-click can be the price that is necessary to keep the advertisement's position above the next advertisement. To determine the actual cost-per-click, the system 104 can determine how much the advertiser in position 1 would have to pay to give it a rank equal to the advertiser in position 2, and then the system 104 adds a unit amount, e.g., $0.01, to this determined amount.

To determine how much the advertiser in position 1 would have to pay to give it a rank equal to the advertiser in position 2, the rank of position 2 can be divided by the quality score of position 1 and $0.01 can be added to that amount. The last advertiser in the list can pay a minimum cost-per-click to hold the position in the list. The minimum cost-per-click can be determined for each advertisement, and can be based on the quality of the advertisement. For example, suppose the minimum cost-per-click is $0.20. The actual cost-per-click of advertisers A, B, and C can be determined as follows:

A: C's rank/A's quality score=1.0/3=$0.33+$0.01=$0.34

C: B's rank/C's quality score=0.75/1=$0.75+$0.01=$0.76

B: minimum cost-per-click=$0.20

In this example, advertiser A would only have to pay $0.34 to hold the first position in the list of advertisements. C would have to pay $0.76 to hold the second position. Advertiser B would be required to pay the minimum cost-per-click amount of $0.20.

The advertisements, associated usage data, and bidding parameters described above can be stored as advertisement data in an advertisement data store 114. An advertiser 102 can further manage the serving of advertisements by specifying an advertising campaign. The advertising campaign can be stored in campaign data in a campaign data store 116, which can, for example, specify advertising budgets for advertisements, and when, where and under what conditions particular advertisements may be served for presentation. For example, a computer company may design an advertising campaign for a new laptop computer that is scheduled to be released on April 23. The advertising campaign may have an advertising budget of $100,000, and may have 30 different advertisements that are to be served for presentation during the month of April. Such data defining the advertisement campaign can be stored in the campaign data 116.

Adjusting Quality Scores based upon a Response Type

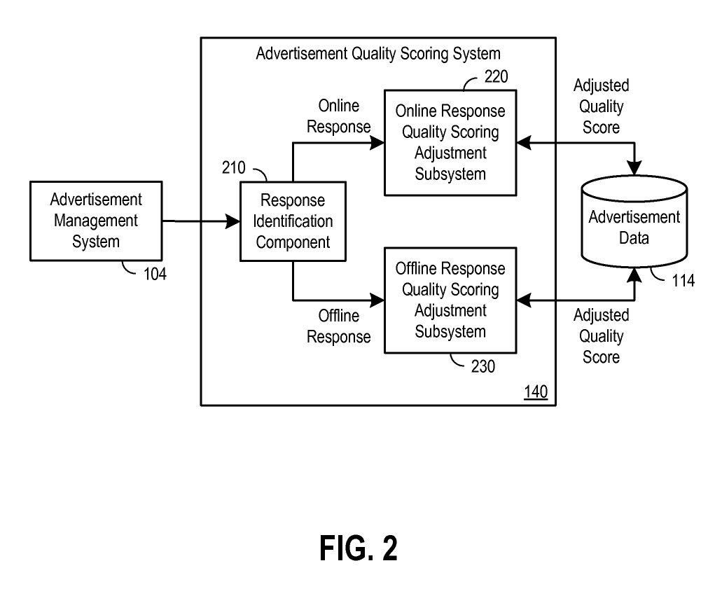

FIG. 2 is a block diagram of an example advertisement quality scoring system 140. In some implementations, the advertisement quality scoring system 140 can include a response identification component 210, an online response quality scoring adjustment subsystem 220, and an offline response quality scoring adjustment subsystem 230. The response identification component 210 can receive notification of a response to an online advertisement from the advertisement management system 104 (e.g., through the offline advertisement tracking subsystem 150 or an online advertisement tracking subsystem (not shown)). In response to the notification, the response identification component can determine whether the response received is an online response or an offline response. If the response is an online response, the response identification component 210 can provide notification to the online response quality scoring adjustment subsystem 220. If the response is an offline response, the response identification component 210 can provide notification to the offline response quality scoring adjustment subsystem 230.

The online response quality scoring adjustment subsystem 220 can adjust the quality of the online advertisement based upon a quality factor associated with the online response. In some implementations, the quality factor can be identified based upon the quality of the online response. For example, an online conversion event (an online purchase) can be associated with a higher quality factor than a click-through.

The offline response scoring quality adjustment subsystem 230 can adjust the quality of the online advertisement based upon a quality factor associated with the offline response. In some implementations, the quality factor can be identified based upon the quality of the offline response. For example, an offline conversion event (a purchase) as identified through use of a coupon can be associated with a higher quality factor than a telephone call to the business associated with the advertisement.

The offline and online response quality scoring adjustment subsystems 220, 230 can retrieve current quality score information for the advertisement from an advertisement data store 114. The quality adjustment subsystems 220, 230 can adjust the current quality score information for the advertisement based upon the quality factor associated with the online or offline response. The adjusted quality scores associated with the advertisement can be stored to an advertisement data store, replacing a current quality score associated with the advertisement.

### Tracking Offline Responses

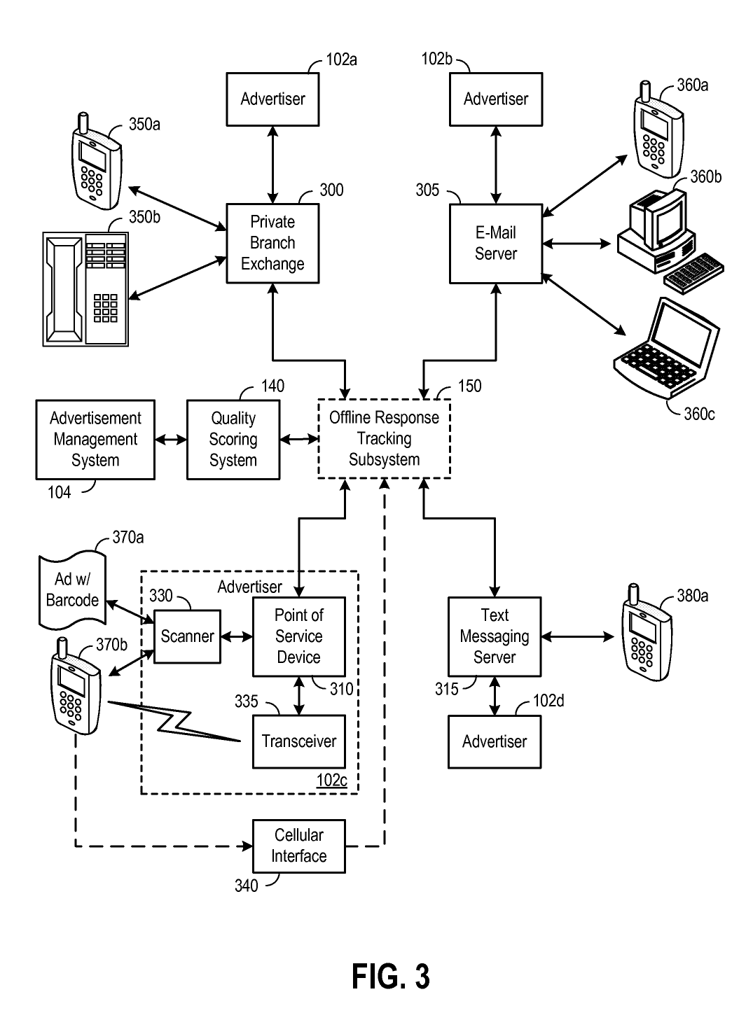

FIG. 3 is a block diagram of an example offline response tracking subsystem 150. The offline response tracking subsystem 150 can communicate with one or more of a PBX 300, an e-mail server 305, an advertiser point of service/sale (PoS) device 310, or a text messaging server 315.

In those implementations where an online advertisement includes a telephonic offline response mechanism, the offline response tracking subsystem 150 can communicate with a PBX 300. The offline response mechanism (e.g., telephone number) can be set up, for example, to identify the PBX 300 instead of directly dialing a business associated with the advertisement. The PBX 300, upon receiving a connection request from a user device 350a or 350b can identify the business associated with the advertisement based upon the number (address) to which the connection request is directed. For example, each advertisement with a telephonic offline response mechanism can be assigned a unique telephone number identifying the business to which the connection request should be routed. The PBX 300 can thereby route the connection request to the business.

In various implementations, the user can initiate the connection request by manually dialing the telephone number associated with the online advertisement, or by selecting the number using a mobile communications device (e.g., cellular phone).

In addition to routing the connection request to the business associated with the advertisement, the PBX 300 can also send a signal to the offline response tracking subsystem 150 to notify the offline response tracking subsystem 150 that an offline response has been received. The offline response tracking subsystem 150 can thereby provide notification to the advertisement quality scoring system 140.

In those implementations where an online advertisement includes an e-mail offline response mechanism, the offline response tracking subsystem can communicate with an e-mail server 305. The offline response mechanism (e.g., e-mail address) can be set up, for example, to route through an e-mail server associated with the offline response tracking subsystem 150. When e-mail to the address identified in the advertisement is received from a user 360a, 360b, 360c, the e-mail server 305 can identify the advertisement with which the e-mail is associated, and can forward the e-mail to an e-mail address for a business associated with the advertisement. In such implementations, the identity of the user can be obfuscated to protect the privacy of the user. Such obfuscation can also facilitate further tracking of the communication between the user and the advertiser because such communications travel through the intermediary e-mail server 305 (e.g., proxy server) associated with the offline response tracking subsystem 150.

In addition to routing the e-mail to the business associated with the advertisement, the e-mail server 305 can also send a signal to the offline response tracking subsystem 150 to notify the offline response tracking subsystem 150 that an offline response has been received. The offline response tracking subsystem 150 can thereby provide notification to the advertisement quality scoring system 140.

In other implementations, a client associated with the business identified by the e-mail address can include software operable to signal the offline response tracking system when an e-mail identifying the advertisement is received. For example, an e-mail header might include a token that causes notification to be provided to the offline response tracking subsystem 150. Thus, when the e-mail offline response mechanism is selected, an e-mail pre-populated with the e-mail address and the token is generated for sending to the business associated with the advertisement. Upon receiving the e-mail, a plug-in tracking component to the business' e-mail client can parse the message, identify the token and communicate with the offline response tracking subsystem 150 based upon identifying the token in the message. The offline response tracking subsystem 150 can thereby instruct the advertisement quality scoring system 140 to adjust the quality score associated with the online advertisement as a result of the identified offline response.

In those implementations where an online advertisement includes a coupon offline response mechanism, the offline response tracking subsystem 150 can communicate with an advertiser's PoS device 310. In some implementations, the PoS device can be coupled to a scanner 330 (e.g., a barcode scanner). In some examples, the barcode scanner 330 can scan a printout of the advertisement 370a for a barcode included in the advertisement as the offline response mechanism. In other examples, the barcode scanner 330 can scan a barcode from a screen associated with a user device 370b. The barcode scanner 330 can communicate the barcode information back to the PoS device 310.

In some implementations, receipt of the barcode information can cause the PoS device 310 to apply a discount to the item(s) or service(s) being purchased by the user. The receipt of the barcode information can also cause the PoS device 310 to communicate the offline response to the offline response tracking subsystem 150. The offline response tracking subsystem 150 can thereafter instruct the advertisement quality scoring system 140 to adjust a quality score associated with the advertisement based upon identification of the offline response.

In other implementations, a mobile communications device 370b can communicate an electronic coupon wirelessly to a wireless transceiver 335 associated with the PoS device 310. The communications can be provided in any of a variety of wireless formats, including, e.g., Bluetooth™, IEEE 802.11 standards, infrared, RFID, and cellular standards. Upon receiving the electronic coupon, the PoS device 310 can confirm receipt and provide a confirmation code back to the mobile communications device 370b through the transceiver 335. The confirmation code can thereby cause the mobile communications device 370b to communicate the confirmation code to the offline response tracking subsystem 150, e.g., through a cellular interface 340.

In those implementations where an online advertisement includes a text messaging offline response mechanism, the offline response tracking subsystem 150 can communicate with a text messaging server 315. The offline response mechanism (e.g., text message address) can be set up, for example, to route through a text messaging server associated with the offline response tracking subsystem 150. When a text message to the text messaging address identified in the advertisement is received from a user 380a, the text messaging server 315 can identify the advertisement with which the text message is associated, and can forward the text message to a text messaging address for a business associated with the identified advertisement. In such implementations, the identity of the user responding to the advertisement can be obfuscated to protect the privacy of the user. Such obfuscation can also facilitate further tracking of the communication between the user and the advertiser because such text messaging communications travel through the intermediary text messaging server 315 associated with the offline response tracking subsystem 150.

In addition to routing the text message to the business associated with the advertisement, the text messaging server 315 can also send a signal to the offline response tracking subsystem 150 to notify the offline response tracking subsystem 150 that an offline response has been received. The offline response tracking subsystem 150 can thereby provide notification to the advertisement quality scoring system 140 to adjust a quality score associated with the advertisement based upon the offline response.

### Example Quality Adjustment Processes for Offline Responses

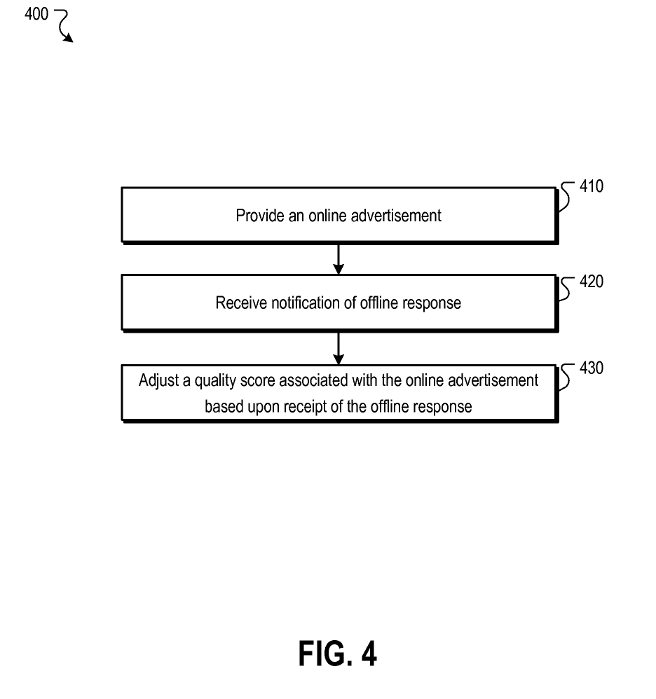

FIG. 4 is a flowchart of an example method 400 for adjusting the quality of online advertisements based upon offline responses. At stage 410, an online advertisement is provided. The online advertisement can be provided, for example, by an advertisement management system (e.g., advertisement management system 104 of FIG. 1). The online advertisement can include an offline response mechanism. In various implementations, the offline response mechanism can include one or more of a phone number, an e-mail address, an instant messaging address, a text messaging address, an electronic coupon, or a store location. The online advertisement can be provided based upon a quality score associated with the online advertisement. In various implementations, the online advertisement can also be provided based upon any of a degree of match between keywords provided in a search query or publisher web site, a highest maximum bid associated with the advertisement, an online response rate (e.g., CTR), or a landing page quality.

At stage 420, a notification of identification of an offline response is received. The notification of the identification of an offline response can be received, for example, by an offline response tracking system (e.g., offline response tracking subsystem 150 of FIG. 1). In some implementations, identifying an offline response can include identifying a type of offline response received. The offline response can be routed, for example, through a server (e.g., an e-mail server, a phone exchange (e.g., PBX), a text messaging server, or a PoS device). The server can communicate identification of an offline response associated with the advertisement to the offline response tracking system.

At stage 430, a quality score associated with the online advertisement is adjusted based upon receipt of the offline response. The quality score can be adjusted, for example, by an advertisement quality scoring system (e.g., advertisement quality scoring system 140 of FIG. 1). In some implementations, a quality score adjustment factor can be identical for all types of offline responses such that, for example, a quality score adjustment factor for coupon use is the same as a quality score adjustment factor for a telephone call. In other implementations, a quality score adjustment factor can vary based upon the type of offline response identified such that, for example, a quality score adjustment factor for coupon use is higher than a quality score adjustment factor for a telephone call.

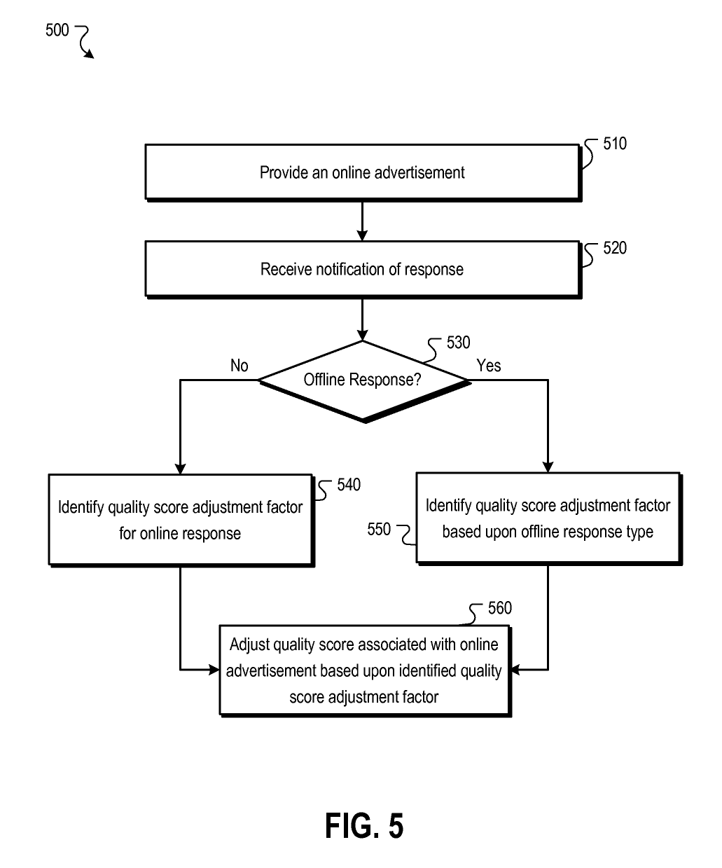

FIG. 5 is a flowchart of another example method 500 for adjusting the quality of online advertisements based upon offline responses or online responses. At stage 510, an online advertisement is provided. The online advertisement can be provided, for example, by an advertisement management system (e.g., advertisement management system 104 of FIG. 1).

At stage 520, a notification a response is received. The notification of the response can be received, for example, by an advertisement management system (e.g., advertisement management system 104 of FIG. 1) in conjunction with an offline response tracking system (e.g., offline response tracking subsystem 150 of FIG. 1). In some implementations, the response to the advertisement can include an offline response or an online response.

At stage 530, a determination of whether the response is an offline response is made. The determination of whether the response is an offline response can be made, for example, by a response identification component (e.g., response identification component 210 of FIG. 2).

If the response is not an offline response, a quality score adjustment factor for an online response is identified at stage 540. The quality score adjustment factor for an online response can be identified, for example, by an online response quality scoring adjustment system (e.g., online response quality scoring adjustment subsystem 220 of FIG. 2). In some implementations, a quality score adjustment factor can be identical for all types of online responses such that, for example, a quality score adjustment factor for an online purchase (e.g., conversion) is the same as a quality score adjustment factor for a click-through. In other implementations, a quality score adjustment factor can vary based upon the type of online response identified such that, for example, a quality score adjustment factor for an online purchase is higher than a quality score adjustment factor for a click-through.

If the response is an offline response, a quality score adjustment factor for an offline response is identified at stage 550. The quality score adjustment factor for an offline response can be identified, for example, by an offline response quality scoring adjustment system (e.g., offline response quality scoring adjustment subsystem 230 of FIG. 2). In some implementations, a quality score adjustment factor can be identical for all types of online responses. In other implementations, a quality score adjustment factor can vary based upon the type of online response identified. For example, a quality score adjustment factor for an online purchase may be higher than a quality score adjustment factor for a click-through.

At stage 560, a quality score associated with online advertisement is adjusted based upon an identified quality score adjustment factor. The quality score can be adjusted, for example, by a quality score adjustment system (e.g., online response quality scoring adjustment subsystem 220 or offline response quality scoring adjustment subsystem 230 of FIG. 2). In some implementations, the adjusted quality score for the advertisement can be stored in an advertisement information data store for use in future advertising placement auctions.

While the above described implementations have focused on adjustment of quality scores associated with advertisements, it should be understood that the result of adjusting quality scores for advertisements is the adjustment of an effective bid for an advertisement in those auctions which use a cost-per-action based billing paradigm (e.g., cost-per-click or cost-per-conversion). Thus, serving better advertisements results in more revenue for the publisher and better exposure for the advertiser. However, it should also be understood that providing better quality advertisements also results in higher user satisfaction in those auctions using a cost-per-impression based billing paradigm.

The various aspects of the described techniques and all of the described functional operations can be implemented in digital electronic circuitry, or in computer software, firmware, or hardware, including the structures disclosed in this specification and their structural equivalents, or in combinations of one or more of them. The described techniques can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The described processes and logic flows can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject matter of this specification has been described in terms of particular embodiments, but other embodiments can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims. The same experimental techniques work for any web page, not merely advertising landing pages. Any web site owner can experimentally determine how good his or her web site design is and which web pages should be targeted for improvement. The web site owner merely needs to designate a test page and a goal page. A goal rate can be calculated as the percentage of browsing users who, having reached the test page, go on to reach the goal page. The goal rate can be interpreted as a measure of success. In this specification, in order to adopt the commonly used terminology, “landing page” is used to include all test pages whether or not arrived at through an advertisement, and “conversion page” is used to include all goal pages.

These and other implementations are within the scope of the following claims.

What is claimed is:

1. A computer-implemented method for providing online advertisements, the method comprising:
providing an online advertisement that includes an offline response mechanism, the online advertisement being provided based upon a quality score associated with the online advertisement;
receiving notification of an offline response to the online advertisement; and
adjusting the quality score associated with the online advertisement based upon receiving the notification of the offline response.

2. The computer-implemented method of claim 1, further comprising, after adjusting the quality score, providing the online advertisement again based upon the adjusted quality score.

3. The computer-implemented method of claim 1, wherein the offline response mechanism comprises a telephone number, the telephone number identifying an exchange associated with a tracking system operable to provide notification of the offline response upon receipt of a telephone call and to forward the telephone call to a business entity associated with the advertisement.

4. The computer-implemented method of claim 1, wherein the offline response mechanism comprises a coupon operable to cause a point of service device to communicate transaction information to a tracking system operable to provide notification of the offline response upon receipt of the transaction information.

5. The computer-implemented method of claim 1, wherein:
the offline response mechanism comprises a coupon,
selection of the coupon from a user device is operable to cause the user device to transmit a signal to a point of service device upon selection of the coupon, and
the user device is operable to provide transaction information to a tracking system operable to provide notification of the offline response upon receipt of the transaction information.

6. The computer-implemented method of claim 5, wherein the user device is operable to receive a transaction confirmation of the transaction from the point of service device prior to providing transaction information to a tracking system.

7. The computer-implemented method of claim 6, wherein the transaction information comprises a transaction code operable to inhibit a user device from providing false notification.

8. The computer-implemented method of claim 1, wherein the offline response mechanism comprises an e-mail address, the e-mail address identifying an e-mail server associated with a tracking system operable to provide notification of the offline response upon receipt of a message, the e-mail server being operable to forward the message to a business associated with the advertisement.

9. The computer-implemented method of claim 1, wherein the offline response mechanism comprises a text messaging address, the text messaging address identifying a text message server associated with a tracking system operable to provide notification of the offline response upon receipt of a message, the text message server being operable to forward the text message to a mobile communications device associated with the advertisement.

10. The computer-implemented method of claim 1, wherein adjusting the quality score associated with the online advertisement comprises:
identifying a type of offline response generated by the online advertisement;
determining a quality score adjustment factor based upon the type of offline response generated by the online advertisement; and
adjusting the quality score based upon the quality score adjustment factor.

11. The computer-implemented method of claim 1, wherein the advertisement further comprises an online response mechanism, and the method further comprises:
receiving notification of an online response to the online advertisement; and
adjusting the quality score associated with the advertisement based upon the online response;
wherein the online response comprises a lower quality response than the offline response, and the quality score is adjusted further based upon the offline response.

12. One or more computer readable media, operable to cause one or more data processing apparatuses to perform operations comprising:
providing an online advertisement that includes an offline response mechanism, the online advertisement being provided based upon a quality score associated with the online advertisement;
receiving notification of an offline response to the online advertisement; and
adjusting the quality score associated with the online advertisement based upon receiving notification of the offline response.

13. The one or more computer readable media of claim 12, wherein the one or more computer readable media are further operable to cause one or more data processing apparatuses to, after adjusting the quality score, provide the online advertisement again based upon the adjusted quality score.

14. The one or more computer readable media of claim 12, wherein the offline response mechanism comprises a telephone number, the telephone number identifying an exchange associated with a tracking system operable to provide notification of the offline response upon receipt of a telephone call and to forward the telephone call to a business entity associated with the advertisement.

15. The one or more computer readable media of claim 12, wherein the offline response mechanism comprises a coupon operable to cause a point of service device to communicate transaction information to a tracking system operable to provide notification of the offline response upon receipt of the transaction information.

16. The one or more computer readable media of claim 12, wherein:
the offline response mechanism comprises a coupon,
selection of the coupon from a user device is operable to cause the user device to transmit a signal to a point of service device upon selection of the coupon, and
the user device is operable to provide transaction information to a tracking system operable to provide notification of the offline response upon receipt of the transaction information.

17. The one or more computer readable media of claim 16, wherein the user device is operable to receive a transaction confirmation of the transaction from the point of service device prior to providing transaction information to a tracking system.

18. The one or more computer readable media of claim 17, wherein the transaction information comprises a transaction code operable to inhibit a user device from providing false notification.

19. The one or more computer readable media of claim 12, wherein:
the offline response mechanism comprises an e-mail address,
the e-mail address identifies an e-mail server associated with a tracking system operable to provide notification of the offline response upon receipt of a message, and
the e-mail server is operable to forward the message to a business associated with the advertisement.

20. The one or more computer readable media of claim 12, wherein:
the offline response mechanism comprises a text messaging address,
the text messaging address identifies a text message server associated with a tracking system operable to provide notification of the offline response upon receipt of a message, and
the text message server is operable to forward the text message to a mobile communications device associated with the advertisement.

21. The one or more computer readable media of claim 12, wherein adjusting the quality score associated with the online advertisement comprises:
identifying a type of offline response generated by the online advertisement;
determining a quality score adjustment factor based upon the type of offline response generated by the online advertisement; and
adjusting the quality score based upon the quality score adjustment factor.

22. The one or more computer readable media of claim 12, wherein the advertisement further comprises an online response mechanism, and the computer readable media is further operable to cause the one or more data processing apparatuses to perform operations comprising:
receiving notification of an online response to the online advertisement; and
adjusting the quality score associated with the advertisement based upon the online response;
wherein the online response comprises a lower quality response than the offline response, and the quality score is adjusted further based upon the offline response.
